(19) United States
(12) Patent Application Publication
(10) Pub. No.: US 2021/0019699 A1
(43) Pub. Date: Jan. 21, 2021

(54) UNMANNED AERIAL VEHICLE (UAV) DELIVERY WITH DROP BEACON

(71) Applicant: Landr, Inc., Palo Alto, CA (US)

(72) Inventors: Matthew Timothy Bornski, San Jose, CA (US); Michael Benjamin Selkowe Fertik, Palo Alto, CA (US)

(21) Appl. No.: 16/930,071

(22) Filed: Jul. 15, 2020

Related U.S. Application Data
(60) Provisional application No. 62/875,219, filed on Jul. 17, 2019.

(51) Int. Cl. G06Q 10/08; G08G 5/00; G05D 1/00; B64C 39/02; H04W 4/80

(52) U.S. Cl. CPC G06Q 10/0833; G06Q 10/0832; G08G 5/0069; G08G 5/003; B64C 2201/145; B64C 39/024; H04W 4/80; B64C 2201/128; G05D 1/0022

(57) ABSTRACT

Methods, systems, and apparatus, including computer programs encoded on computer storage media, for drone delivery. One of the methods includes: receiving, at the UAV, information about a location of a drop beacon comprising GPS coordinates of a location of a drop beacon; navigating the UAV towards the location based on the information using GPS coordinates of the drop beacon; when reaching a proximity of the drop beacon, transmitting a first radio signal from the UAV with information relatable by the drop beacon; receiving, at the UAV, a second radio signal from the drop beacon; identifying, at the UAV, a line-of-sight signal from the drop beacon; navigating the UAV to the drop beacon based on the line-of-sight signal; and delivering, from the UAV, the goods to the location of the drop beacon.

### CROSS-REFERENCE TO RELATED APPLICATIONS

This claims priority to Provisional Application No. 62/875,219, entitled UNMANNED AERIAL VEHICLE (UAV) DELIVERY WITH DROP BEACON, filed on Jul. 17, 2019, the entire contents of which is incorporated herein by reference.

### BACKGROUND

This specification relates to unmanned vehicles, including unmanned aerial vehicles (“UAVs”). Specifically, this specification relates to performing deliveries by UAVs.

### SUMMARY

This specification describes technologies for managing a beacon network of beacons designating drop sites for UAVs to deliver goods. These technologies generally involve a UAV dispatch system maintaining a network of beacons and receiving drop requests from a number of operators. Operators operate UAVs for making deliveries in response to orders from customers. Drop sites are maintained by corresponding beacon hosts that provide a safe and viable landing location for UAVs to make deliveries. Operators make drop requests to the UAV dispatch system, and the UAV dispatch system generates drop information, including an assignment to a currently active drop site close to a customer's geographic location.

After being assigned a drop site, a UAV can navigate to the drop site and begin a final descent. To facilitate a safe and accurate delivery, a drop beacon for the drop site can authenticate its identity to the UAV. Afterwards, or contemporaneously, the UAV and the drop beacon can establish a line-of-sight connection to help the UAV guide itself towards a safe landing.

Multiple UAVs can handle deliveries to one or more drop beacons at the same time, and the UAV dispatch system can schedule more than one UAV to deliver a corresponding package to the same drop site. The UAV dispatch system can deconflict and prioritize different UAVs over others to facilitate an efficient and safe chain of deliveries at the drop site. The scheduling and prioritization can be based on logistics, such as a volume or traffic at certain drop sites requiring a priority queue of deliveries; or the prioritization can be based on value-added services provided to a customer.

The subject matter described in this specification can be implemented in particular embodiments so as to realize one or more of the following advantages. A UAV dispatch system can coordinate deliveries by one or more operators independent of the UAV dispatch system to UAV drop sites. UAV drop sites can be maintained by beacon hosts wherever a beacon host can ensure a safe and viable location for UAV deliveries. A drop beacon for a corresponding drop site can safely guide a UAV on a final descent, even in suburban and urban settings and with potentially other UAVs also making deliveries to the drop site. In addition, a UAV dispatch system that includes a beacon network can implement a number of protocols through a drop beacon to authenticate the drop beacon to a delivering UAV and maintain a chain of custody for accountability of a delivery from a vendor to the customer. The dispatch system can flexibly increase or decrease authentication requirements to maintain a chain of custody of a delivery to a customer, by designating a beacon host for a drop beacon as “high-trust” or “low-trust” based on different factors, including a history of successful or failed deliveries at the drop beacon and customer ratings of the drop site and/or the beacon host.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of a UAV dispatch system interacting with one or more operators.

FIG. 2 illustrates a block diagram of a portable drop beacon 200.

FIG. 3 is a flowchart of example interactions between parties during a delivery.

FIG. 4 is a screenshot of an example user interface shown on a customer device for selecting a location to receive goods ordered on an application.

FIG. 5 is a flowchart of example interactions between parties for performing an authentication protocol during delivery to a drop site.

FIGS. 6-8 illustrate an example delivery by a UAV according to one implementation.

FIG. 9 illustrates an example delivery by a UAV according to another implementation.

FIG. 10 is a flowchart of an example process for a UAV to locate and arrive at a drop site indicated by a drop beacon in an area representing an approximate location.

FIG. 11 is a flowchart of an example process for matching a drop request to an available drop beacon, and confirming delivery by a UAV at the drop beacon location.

FIG. 12 is a flowchart of an example process for managing airspace at a drop site designated by a drop beacon.

Like reference numbers and designations in the various drawings indicate like elements.

### DETAILED DESCRIPTION

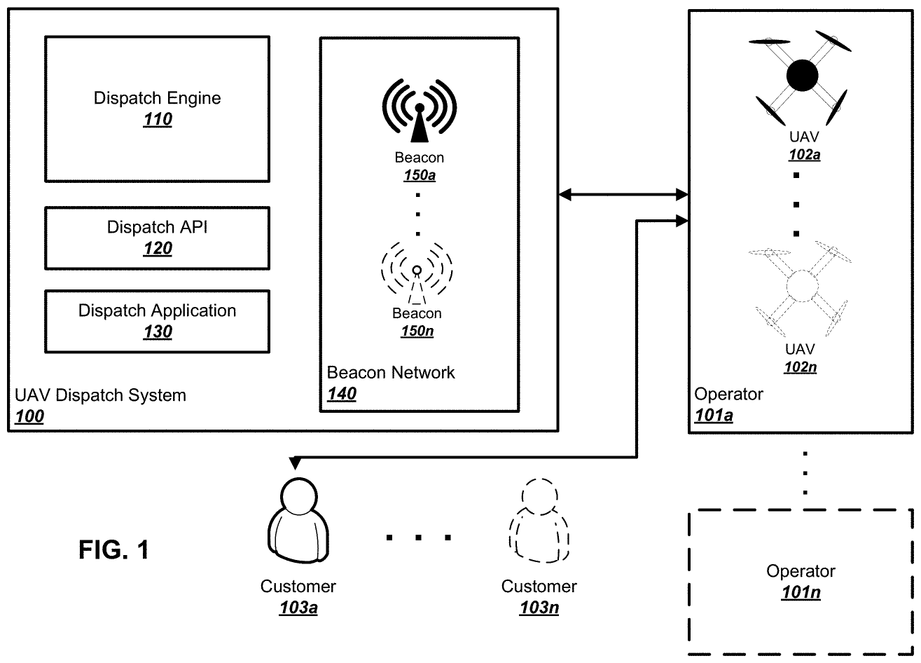

FIG. 1 is a block diagram of a UAV dispatch system 100 interacting with one or more operators 101a-n. UAV dispatch system 100 can include a dispatch engine 110, a dispatch API 120, a dispatch application 130, and a beacon network 140 of one or more drop beacons 150a-n. Each operator can operate one or more UAVs. For example and in FIG. 1, operator 101a is shown operating one or more UAVs 102a-n.

In general, operators 101a-n can receive a number of orders for goods from one or more customers 103a-n. A good is any tangible product, e.g., socks or burritos, suitable for UAV delivery. An operator receiving an order can send a drop request to UAV dispatch system 100, and the system can respond by assigning a drop beacon of drop beacons 150a-n in beacon network 140 as a designated drop site. A drop site is a geographic space designated for UAV deliveries and includes a drop beacon. The drop beacon is portable and defines the drop site, i.e., a drop site is wherever a drop beacon is located within a radius large enough for UAVs to safely make deliveries. The requesting operator can indicate to the ordering customer a drop site to collect a delivery, and the operator can navigate a UAV to the drop site to make the delivery for the ordered goods.

In this specification, description of a UAV can be extended to each UAV 102a-n. For brevity, reference will be made to a single UAV 102. UAV 102 can be any type of UAV appropriately configured to deliver a package by carrying the package from an origin to a destination. For example, UAV 102 can be a fixed-wing UAV, a rotary-wing UAV, or a fixed-wing hybrid UAV. UAV 102 includes a transceiver to receive commands from an operator or to transmit information about UAV 102 to a receiving device, e.g., a drop beacon.

UAV 102 can implement any appropriate technology for navigation. Examples of technologies for navigation include: GPS, GALILEO, GLONASS, BeiDou, QZSS, 5G, 4G, and GPRS. UAV 102 can also implement technologies for establishing a line-of-sight signal with a drop beacon, by techniques described in detail, below. The technologies can include: radio; infrared; and visual identification, such as of a fiducial marker or a QR code on the drop beacon.

In this specification, description of an operator can be extended to each operator 101a-n. For brevity, reference will be made to a single operator 101. An operator of a UAV is an entity that can operate the UAV by issuing commands. An entity is a general term used in this specification and refers to one or more people, one or more enterprises, or one or more organizations. If the entity is an organization or enterprise, then the entity can include one or more people, e.g., employees.

Operator 101 can be a service provider or a vendor. A service provider is an entity that provides a delivery service using UAV 102 and optionally one or more other UAVs. A service provider can sell the goods that are to be delivered, but can also provide a delivery service between a vendor who sells the goods and a customer. In implementations in which the service provider provides a delivery service, the vendor can prepare the package for delivery, which a UAV of the service provider can pick up for delivery.

Alternatively, an operator 101 can be a vendor. The vendor can prepare goods in a package that can be delivered by UAV 102. The package can contain perishable goods like food, or non-perishable goods, like clothing. In implementations in which a vendor is an operator of UAV 102, the vendor can issue commands to UAV 102 to deliver the package without a service provider.

The scope of commands receivable by UAV 102 can vary depending on the configuration of UAV 102. UAV 102 can be configured to receive simple commands to perform a corresponding action, e.g., commands to stop, go, or turn. In some implementations, UAV 102 is configured to receive compound commands that include one or more simple commands. For example, a compound command can be for UAV 102 to go to a drop site indicated by a set of coordinates of a drop beacon. The compound command can involve many simple commands that UAV 102 can be configured to perform automatically, such as commands to navigate and fly to the drop site.

In addition and as described in detail below, upon approaching a drop site, e.g., a drop site corresponding to drop beacon 150a, UAV dispatch system 100 can be configured to coordinate and prioritize delivery through a drop beacon 150a, according to a number of implemented protocols. These protocols can include protocols for authenticating a drop site before making a delivery, deconflicting while near other UAVs also making a delivery to the drop site, and making the delivery with respect to a priority queue of deliveries maintained and adjusted by UAV dispatch system 100 in real-time.

As described below, UAV 102 can receive information corresponding to a drop beacon from operator 101, who receives the information from UAV dispatch system 100. The drop beacon can designate a drop site, which is a location suitable for UAV 102 to make a delivery of a package of goods. With the drop beacon information, UAV 102 can navigate to an approximate location of the drop site, and by techniques described in this specification, be guided by the drop beacon to safely land at the drop site.

UAV 102 can also include different peripherals for recording audio-visual content, for example, cameras, microphones, and audio recorders. Each UAV 102a-n can be of a different model or configuration. Depending on the configuration, a UAV can be capable of making some deliveries, but not others, e.g., because of a weight of the package, or distance between picking up a delivery and an assigned drop site for the UAV.

UAV dispatch system 100 can include dispatch engine 110. In general, dispatch engine 110 can be configured to receive drop requests from operators 101a-n, assign beacon drop sites as destination for a delivery in response to a drop request, and manage delivery according to a number of protocols between a delivering UAV and a network of drop beacons. For brevity of description in this specification, functions described as performed by the UAV dispatch system 100 are executed by dispatch engine 110, appropriately configured to execute those functions.

UAV dispatch system 100 can also include a dispatch API (“Application Programming Interface”) for performing functions described in this specification as performed either by UAV dispatch system 100 or by dispatch application 130. Dispatch application 130 can implement one or more functions of dispatch API 120 for interacting between an operator, customer, or beacon host, and UAV dispatch system 100. Dispatch application 130 can be maintained by UAV dispatch system 100, and operator 101 can install the dispatch application on an appropriately configured computing device, e.g., as a mobile application. Operator 101 can receive orders from customers, and in turn send drop requests corresponding to the orders.

In some implementations, customers can also communicate with operators and UAV dispatch system 100 through the dispatch application, through respective customer accounts. Similarly, beacon hosts—which as described below are entities that maintain drop beacons and respective drop sites for the beacons—can also interact with UAV dispatch system 100 through respective beacon host accounts on the dispatch application.

UAV dispatch system 100 can maintain a number of user accounts corresponding to corresponding entities communicating with UAV dispatch system 100, and with each other. For example, operators, customers, and beacon hosts for drop sites can have respective user accounts on the dispatch application. Depending on the type of entity, each entity can create a user account matching the type of entity, e.g., operator accounts, customer accounts, and beacon host accounts. Depending on the type of account, the dispatch application is configured to provide different functionality to the account, as described below.

In some implementations, customers send orders to operators using an operator application corresponding to operator 101. The operator application can implement one or more functions defined in the dispatch API 120, including functions for receiving an order and automatically sending a drop request to UAV dispatch system 100.

UAV dispatch system 100 includes beacon network 140 that includes one or more beacons 150a-n. Beacon network 140 represents where a UAV can be assigned a drop site location corresponding to a beacon, as a destination for making a delivery. In general UAV dispatch system 100 can assign a drop beacon as a destination for a delivery, in response to a drop request from an operator. The assignment can be based on a customer's location and other factors, including a number of active drop beacons, and a number of UAVs currently in operation.

UAV dispatch system 100 can also be configured to obtain requisite approval from appropriate entities as required by federal, state, or local law of the location in which UAVs are operating. UAV dispatch system 100 can maintain the requisite approval for each UAV, either on behalf of operators operating respective UAVs, or to satisfy legal requirements for a dispatch system that manages UAV flight paths and delivery schedules, but that does not directly operate the UAVs. Similarly, UAV dispatch system 100 can obtain and manage requisite permits for beacon hosts, who, as described below, manage and maintain drop sites corresponding to respective drop beacons. Depending on where drop beacons are deployed, additional permits may be required in compliance with rules and regulations to allow UAVs to fly to, land, and/or take-off from corresponding drop sites at that location.

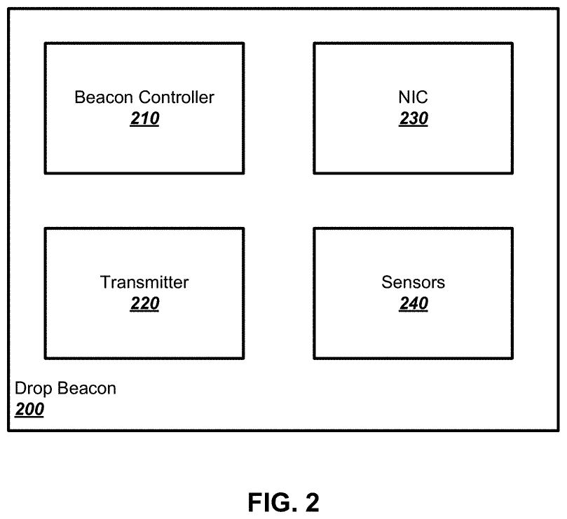

FIG. 2 illustrates a block diagram of a portable drop beacon 200. Drop beacon 200 includes a drop beacon engine 210, a transceiver 220, a network interface controller (“NIC”) 230 for communicating over a network, e.g., the internet, and sensors 240. Transceiver 220 can receive incoming signals from approaching UAVs, and send outgoing signals which can be received by a corresponding transceiver installed on a UAV making a delivery at the drop site corresponding to beacon 200.

Drop beacon 200 can be configured to operate in a low-power state, and in some implementations includes a battery, e.g., for operating when a local power source is not available. Drop beacon 200 can also be configured to operate, e.g., receive deliveries and confirm deliveries, without an active network connection. In those implementations, drop beacon 200 can cache a history of deliveries made at the drop site while drop beacon 200 was offline, and update UAV dispatch system 100 with the history when drop beacon 200 reestablishes a network connection.

Drop beacon 200 can implement any appropriate long-range positioning technology. Examples include: GPS, GALILEO, GLONASS, BeiDou, QZSS, 5G, 4G, and GPRS. Drop beacon 200 can also implement technologies for establishing a line-of-sight signal with a UAV, by a technique described in detail, below. The technologies can include: radio, infrared, and visual identification, such as of a fiducial marker or a QR code on the UAV.

In general, drop beacon 200 is portable and designed to be easily removed from a drop site. As described below, beacon hosts can receive a beacon upon signing up with UAV dispatch system 100 to become a beacon host. Therefore, drop beacon 200 is advantageously easy to transport to facilitate developing a wide beacon network and to facilitate easy installation from entities signing up with the system as beacon hosts.

As described below, in some implementations the approaching UAV and beacon 200 can communicate according to one or more protocols for safely guiding the UAV to the drop site, authenticating the UAV, drop beacon 200, and a receiving customer. Drop beacon engine 210 can be configured to perform operations generally corresponding to transmitting and receiving data to and from UAV dispatch system 100 via transceiver 220. For example, drop beacon engine 210 can be configured to transmit a status of beacon 200, e.g., as active or inactive, to UAV dispatch system 100. For brevity of description in this specification, functions described as performed by beacon 200 are executed by drop beacon engine 210, appropriately configured to execute those functions.

When drop beacon 200 is active, then drop beacon 200 can indicate to UAV dispatch system 100 that it is available to receive UAV deliveries at a drop site designated by drop beacon 200. Conversely, when drop beacon 200 is not active, then drop beacon 200 can indicate to UAV dispatch system 100 that it is not available to receive UAV deliveries at the designated drop site for drop beacon 200. In response, UAV dispatch system 100 will not schedule deliveries to drop beacon 200 while the beacon is inactive.

A drop site can be managed by a beacon host, who is an entity responsible for maintaining the drop site as a destination suitable for UAV deliveries, as well as engaging with customers and UAVs to facilitate delivery of the correct orders to the correct customers. A beacon host can enter in an agreement to maintain a drop site on behalf of UAV dispatch system 100, in exchange for compensation. At a later time, the beacon host can receive and install drop beacon 200. Because drop beacon 200 is portable, a beacon host can easily install a drop beacon at a location with an internet connection and a source of power, and maintain the area proximate to the beacon as a drop site.

For example, a beacon host may be the owner of a parking lot. If the parking lot provides enough space for UAVs to make deliveries, the beacon host can obtain a drop beacon and set the drop beacon to “active,” e.g., through the dispatch application. Thereafter, the parking lot owned by the beacon host becomes a drop site for UAV dispatch system 100 to assign UAVs to make deliveries as appropriate.

Depending on their effectiveness in maintaining the drop site, the beacon host can be rated higher or lower by UAV dispatch system 100. The rating of the beacon host is an indication of the reliability of assigning UAVs to make deliveries at the beacon host's drop site. In some implementations, customers can be prompted by the dispatch application after a successful delivery to rate their experience with the drop site. Higher ratings by the customers reflect a higher overall rating for the beacon host, while lower ratings can negatively impact the overall rating.

In some implementations, the beacon host can maintain a facility for receiving and storing deliveries for orders received on behalf of one or more customers. Sometime after placing the order, a customer can go to the drop site where the order was delivered, and collect the delivery from the facility. The beacon host, as part of an authentication protocol required by the customer when the order was placed, can verify the customer's identity prior to giving the customer the delivered goods.

The beacon host can maintain a facility and not be physically present at the drop site while the drop site is active. In some implementations, the drop beacon maintained by the beacon host can be designated as “high-trust” or an equivalent. A “high-trust” drop beacon is maintained by a corresponding beacon host with higher standards of authentication and security for a respective drop site. An example of a higher standard is that the beacon host is always physically present and verifies each delivery when drop beacon 200 is active.

The UAV dispatch system can designate a level of trustworthiness for a beacon host or drop site associated with drop beacon 200 according to a variety of factors, including factors related to: conditions of the drop site; customer reviews of drop beacon 200; the drop site proximate to drop beacon 200; the beacon host for drop beacon 200; a delivery history for deliveries made at the drop site; and the general location surrounding the drop site. As described below, authentication requirements between a drop beacon and a drop beacon can vary depending on the designated status of a drop beacon.

The beacon host can also maintain the drop site to prevent or reduce hazards associated with multiple UAVs arriving and departing a drop site. For example, in some implementations beacon 200 is configured to detect the presence in obstacles proximate to the beacon, either on the ground or in the air. Beacon 200 can detect the presence of obstacles, for example, through one or more sensors 240 installed on the beacon. Sensors 240 include: cameras, e.g., infrared, near-infrared, or visible-spectrum, and microphones. Upon detecting the presence of an obstacle, beacon 200 can notify the beacon host.

Drop beacon 200 can, in some implementations, categorize obstructions or hazards as “resolvable” or “un-resolvable.” The UAV dispatch system or the beacon host can take an action to address resolvable obstructions, but not un-resolvable obstructions. Resolvable obstructions include, for example, debris or foreign objects at the drop site or obstructing drop beacon 200 that can be removed by a beacon host, and people or animals at or near the drop site.

Un-resolvable obstructions include dangerous weather conditions, UAVs or other airborne obstructions not associated with the UAV dispatch system, or other hazards to a customer, UAV, or both, that would be dangerous or impossible for UAV dispatch system or beacon host to remove. Un-resolvable obstructions can be temporary or persistent. A persistent un-resolvable obstruction can include a hazard that is not specifically identified but known to affect UAVs and/or customers at the location proximate to the drop site. For example, if the location has a history of crime or attacks on customers and/or UAVs, the drop site in general is said to have an un-resolvable obstruction.

A temporary un-resolvable obstruction is an obstruction that, while not resolvable by the UAV dispatch system or the beacon host for a drop beacon, can be resolved naturally over time. For example, local weather conditions or a temporary flight restriction by an appropriate legal entity at the location proximate to the drop site are un-resolvable obstructions that are presumably temporary. The UAV dispatch system can be configured to monitor un-resolvable obstructions for a change in status, e.g., periodically or in response to reports from beacon hosts of affected drop beacons.

In some implementations, the UAV dispatch system can be configured to designate drop beacon 200 as being affected by an un-resolvable obstruction by tracking and analyzing a history of successful and failed deliveries to the drop site corresponding to drop beacon 200. For example, the UAV dispatch system can determine whether a ratio of failed deliveries to successful deliveries to drop beacon 200 meets a pre-determined threshold, and in response, can “blacklist” or reduce the number of deliveries scheduled to that drop site, as described below.

In some implementations, beacon 200 emits a sound or light to indicate an obstacle in the drop site has been detected. In some implementations, beacon 200 is configured to transmit a notification to the beacon host for beacon 200 through a dispatch application installed on a computing device accessed by the beacon host. In those implementations, the beacon host has a beacon host account corresponding to one or more beacons the beacon host maintains. In some implementations, depending on whether the obstruction is resolvable or not, the UAV dispatch system can send a prompt to the beacon host through the dispatch application to address the resolvable obstruction and then confirm when the obstruction is resolved.

Similarly, beacon 200 can submit notifications and information to the beacon host through the dispatch application and that is generally related to the operation of beacon 200 at the drop site. For example, information can include delivery confirmations when a UAV makes a successful delivery at the drop site, successful or failed attempts to authenticate a customer prior to completing a delivery, and a list of UAVs currently within a perceptual range of drop beacon 200.

If the drop site has an un-resolvable obstruction, then in some implementations the UAV dispatch system can be configured to reduce or eliminate scheduled deliveries at that drop site. For example, if the drop site is in a high-crime location with reports of assault on UAVs and/or customers, the UAV dispatch system can be configured to not schedule deliveries at drop beacons at that location. For example, the UAV dispatch system can “blacklist” any drop beacons at that location, or a negatively modify a drop host rating based on the un-resolvable obstruction, which, as a result, can cause the UAV dispatch system to schedule drops at drop beacons in that location less frequently, if at all.

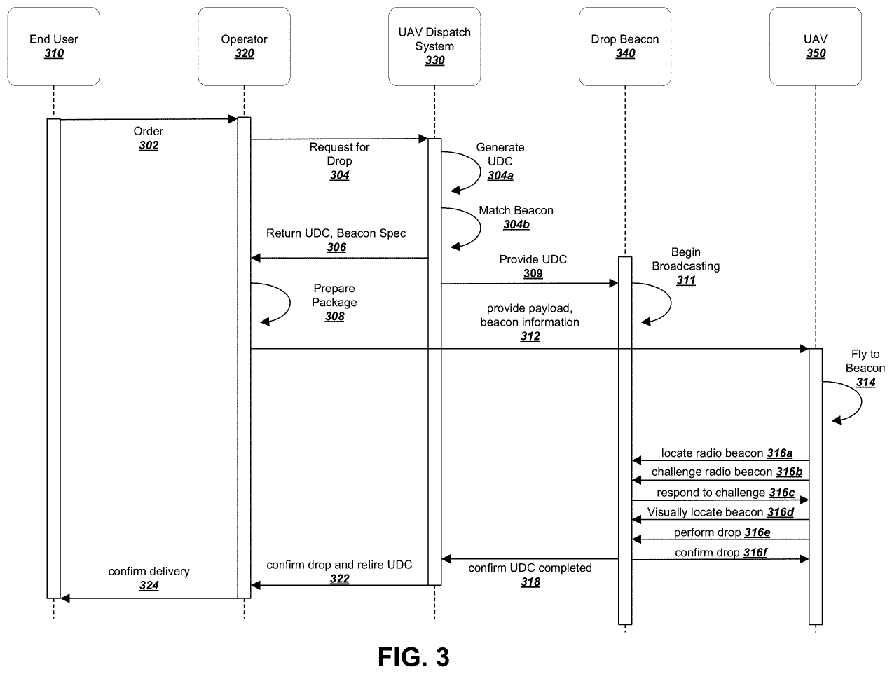

FIG. 3 is a flowchart of example interactions between parties during a delivery. The flowchart includes a customer 310, an operator 320, a UAV dispatch system 330, a drop beacon 340, and a UAV 350.

Customer 310 places an order for a delivery to operator 320 (step 302). The order can be for any good or goods of an appropriate size and weight such that the good can be lifted and carried by UAV 350. For example, customer 310 can place an order for delivery of a burrito to operator 320. Customer 310 can place the order with a number of order parameters, such as a time for delivery or a priority for the provider to fulfill the delivery, e.g., “high,” “medium,” or “low” priority. The order can also include information about the geographic location of customer 310. As described below, UAV dispatch system 330 can assign a drop beacon location to fulfill an order depending on the order parameters, the nature of the ordered good or goods, e.g., perishable or non-perishable, and a geographic location of customer 310. Order parameters can also include whether the assigned drop site should be maintained by a “high-trust” beacon host.

Customer 310 can place an order for a delivery to provider 320 in a variety of different ways. In some implementations, customer 310 places an order using an application on a computing device, for example a dispatch application installed on a mobile device. Customer 310 can interact with the dispatch application to place an order that can be received electronically by provider 320. Provider 320 can receive the order automatically by interacting with the same application, or, for example, by SMS or email. The application used between provider 320 and customer 310 can be maintained or offered by UAV dispatch system 330.

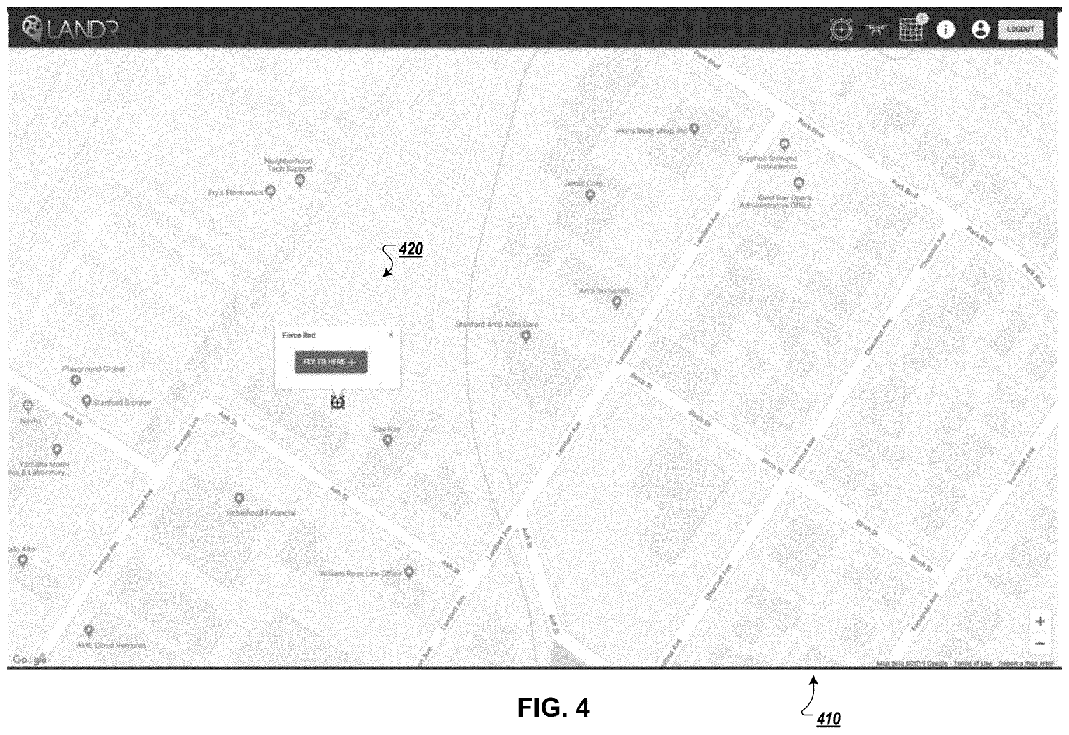

When placing an order, customer 310 can specify a location, e.g., by geographic coordinates, where customer 310 would like to receive the ordered goods. In some implementations, the dispatch application includes a user interface for selecting a location for delivery, as described below with reference to FIG. 4.

The dispatch application can also be configured to provide a dynamic pricing for an order made by customer 310 indicating a cost for placing the order based on order parameters specified by customer 310. Dispatch application can send order parameters to UAV dispatch system 330 to calculate a pricing based on the parameters, prior to customer 310 confirming the order. Then, dispatch application can receive the pricing from UAV dispatch system 330 and display the pricing on a display of a customer device, e.g., through a user interface for the dispatch application. Customer 310 can accept or modify the order parameters through the dispatch application, and receive an updated pricing based on the order parameters (referred to as a dynamic pricing update in this specification).

The dynamic pricing calculated by UAV dispatch system 330 can take into account other factors affecting the cost of service. Other factors include the time of day, the volume of pending drops to be completed scheduled by UAV dispatch system 330, and the location where customer 310 placed an order. Dispatch application can receive continuous pricing updates from UAV dispatch system 330 and, in turn, can prompt customer 310 to update order parameters of the order in exchange for a reduced or increased fee.

For example, if UAV dispatch system 330 identifies a large volume of deliveries to the same drop site, then UAV dispatch system 330 can send a dynamic pricing update to a customer device for customer 310. The dynamic pricing update can be to a lower price, e.g., a discount or a promotional offer for a reduced or free future delivery, in exchange for changing the order parameters to receive the delivery at a later time.

In some implementations, UAV dispatch system 330 factors the nature of the delivery and the condition of the UAV before making a dynamic pricing update to delay the delivery. For example, UAV dispatch system 330 can be configured not to provide a dynamic pricing update that would delay the delivery, if the goods ordered were perishable, e.g., food, or if the UAV is not capable of remaining in operation for an extended period of time without returning to a base to recharge.

As another example, UAV dispatch system 330 can send a dynamic pricing update to a customer device for customer 310 to speed up delivery or update a drop site to one closer geographically to customer 310. Customer 310 can receive a prompt on the dispatch application, confirming or denying the dynamic pricing update.

As another example, UAV dispatch system 330 can send a dynamic pricing update to a customer device for customer 310 before beginning a final descent to the drop site. Where there is a priority queue of UAVs waiting to make a corresponding delivery at the drop site, UAV dispatch system 330 can send a dynamic pricing update to bump the UAV carrying customer 310's order up in the queue, in exchange for added delivery cost to customer 310. In the interim, UAVs in a priority queue can hover a safe distance away from the drop site until they are next in queue to begin a final descent.

In some implementations, customer 310 can place the order by directly contacting provider 320, e.g., by phone or SMS. Provider 320 can receive the order automatically, e.g., through a point-of-sale system configured to receive orders from customers. In some implementations, an employee of the provider 320 can receive the order from customer 310.

Provider 320 requests a new drop from UAV dispatch system 330 (step 304). In general, provider 320 can send a new drop request to UAV dispatch system 330 in any appropriate manner over a network, e.g., by a mobile application maintained or offered by UAV dispatch system 330. In some implementations, customer 310 can send an order on the same application that provider 320 uses to automatically send a new drop request to UAV dispatch system 330.

Drop requests can be requested manually, e.g., by a person working for provider 320 after receiving a delivery request. For example, provider 320 can receive the order from customer 310 and separately request a new drop from UAV dispatch system 330.

The drop request can include the good or goods ordered by customer 310 for delivery and any order parameters specified by customer 310 in the order, including the geographic location of customer 310 and a location for delivery specified by customer 310 as part of the order.

As part of generating a new drop request in response to the request from provider 320, UAV dispatch system 330 generates and assigns a universal drop code (“UDC”) to the drop request (step 304a). A UDC is a unique identifier for each drop request received by UAV dispatch system 330. UAV dispatch system 330 can generate a UDC by any appropriate technique, for example by generating a hash output of the information received from provider 320 for the order. UAV dispatch system 330 maintains a data structure of pending, completed, and canceled deliveries, identified by UDC.

In some implementation, the data structure includes a ledger of transactions, that user accounts can access to check a delivery history for deliveries the entity of the user account was involved in, e.g., a customer checking their order, an operator checking a delivery for an order they facilitated, or a beacon host checking an order they received at their respective drop site. The ledger, for example, can be implemented by blockchain technology.

UAV dispatch system 330 matches the drop request with drop beacon 340 (step 304b). In general, UAV dispatch system 330 can match the drop request to a beacon based on a number of criteria that balance the demands of a customer with technical considerations and logistics of scheduling a number of UAVs making deliveries at a beacon potentially at the same time. In addition, UAV dispatch system 330 can offer value-added services to shift the balance between customer demand and cost associated with meeting customer demand, e.g., in the form of dynamic pricing updates, described above.

UAV dispatch system 330 can be configured to time-out after a predetermined period of time if UAV dispatch system 330 cannot provide a match for a received drop request. In those cases, UAV dispatch system 330 can notify operator 320 that a drop request could not be made, and additionally notify customer 310 if customer 310 placed the order through the dispatch application. Reasons for not matching a drop request with a corresponding drop beacon include: no drop beacon within a predetermined range of customer 310 and candidate drop sites are at-capacity with other pending deliveries. In response to not providing a match for the drop request, UAV dispatch system 330 can send a dynamic pricing update to customer 310, e.g., to reduce the cost of delivery in exchange for a later delivery time or different drop site.

A description of implementations of a UAV dispatch system matching drop beacons to a drop request follows. In some implementations, the UAV dispatch system 330 matches a drop request by proximity to a customer location or other location specified in the drop request. For example, customer 310 specifies a desired location to pick up a delivery, and UAV dispatch system 330 can identify and assign a beacon in the beacon network closest to the desired location.

In some implementations, the dispatch application can prompt a customer for a desired drop site from a list of available drop site options, e.g., through a user interface of the dispatch application. The dispatch application sends a request for a list of currently active beacons to UAV dispatch system 330, and in response receives a list to populate the user interface for the dispatch application.

The dispatch application can provide each drop site option with a corresponding cost to schedule a delivery for the customer's order at the drop site, e.g., as a dynamic pricing update. For example, the dispatch application can assign a higher cost for drop site options physically closer to customer 310 or a desired drop site for customer 310. The dispatch application can request an updated cost schedule from UAV dispatch system 330, which, as described below, can be configured to update an assigned drop site for a delivery—and its corresponding cost—in real-time while the UAV is in transit. From the perspective of the dispatch application, the dispatch application can continuously receive updates from UAV dispatch system vis-a-vis changes in a scheduled delivery.

UAV dispatch system 330 sends the UDC and drop beacon information to operator 320 (step 306). In some implementations, if customer 310 sent the order through the dispatch application, then UAV dispatch system 330 can also send the UDC and drop beacon information to customer 310. The dispatch application on the computing device of customer 310 can receive the UDC and drop information for display to customer 310. In some implementations, the dispatch application can be configured to provide an option to confirm a delivery or change characteristics of the delivery, e.g., changing the assigned drop site.

For example, as part of load-balancing deliveries by multiple UAVs, UAV dispatch system 330 can send an indication that an assigned drop site for the delivery is experiencing high traffic volume among other UAVs assigned to the drop site. In response, the dispatch application can prompt customer 310 to select an alternative drop site or delay the delivery as part of a dynamic pricing update calculated by UAV dispatch system 330. UAV dispatch system 330 can also suspend assigning drop requests to the congested drop beacon until traffic volume has decreased.

Next, operator 320 prepares the package for delivery (step 308). As described above with reference to FIG. 1, operator 320 can be a service provider or a vendor. If operator 320 is a vendor, then operator 320 prepares the ordered goods for delivery in a package suitable for transport by a UAV. If operator 320 is a service provider, then operator 320 can command a UAV to pick up a prepared package of goods from a vendor.

UAV dispatch system 330 provides the UDC for the drop request to drop beacon 340 (step 309) and in response, drop beacon 340 begins broadcasting a signal for UAV 350 to pick up as it approaches drop beacon 340 (step 311). In some implementations, drop beacon 340 is consistently emitting a signal when active, for example because drop beacon 340 has a local power source and is not dependent on a battery with limited charge.

Operator 320 provides the package, assigned UDC, and drop beacon information to UAV 350 (step 312). With the drop beacon information, which can include coordinates of drop beacon 340, UAV 350 can begin flying towards the assigned drop site.

UAV 350 flies to an approximate location of drop beacon 340 (step 314). An approximate location varies from UAV to UAV, but in general refers to an area encircling the drop site in which the effectiveness of conventional techniques for guiding UAV 350 to drop beacon 340 are diminished below a predetermined threshold. For example, the reliability of a positioning system used by UAV 350 can be diminished as the UAV approaches the drop site, e.g., because of the “urban canyon” effect in which positioning signals to and from a satellite are obstructed by man-made obstacles, like buildings. As part of implementations of the described subject matter, drop beacon 340 can be configured to guide UAV 350 as it makes its final descent to the drop site.

UAV 350 begins final descent to the drop site designated by drop beacon 340 (step 316). To do so, the final descent is described below with reference to steps 316a-e. In some implementations, before beginning the final descent to the drop site, UAV dispatch system 330 can compute and send a dynamic pricing update to the customer device of customer 310, through the dispatch application. The dynamic pricing update can update a cost for delivering the order sooner or later, e.g., depending on the length of a priority queue of other UAVs waiting to descend to the drop site.

UAV 350 establishes a communication link with drop beacon 340 (step 316a). Specifically, a communication link with drop beacon 340 can be established by any appropriate technology, e.g., radio. To do this, UAV 350 must locate drop beacon 340, which it can do, for example, because drop beacon 340 previously began emitting a signal after receiving an indication of a new drop through a received UDC.

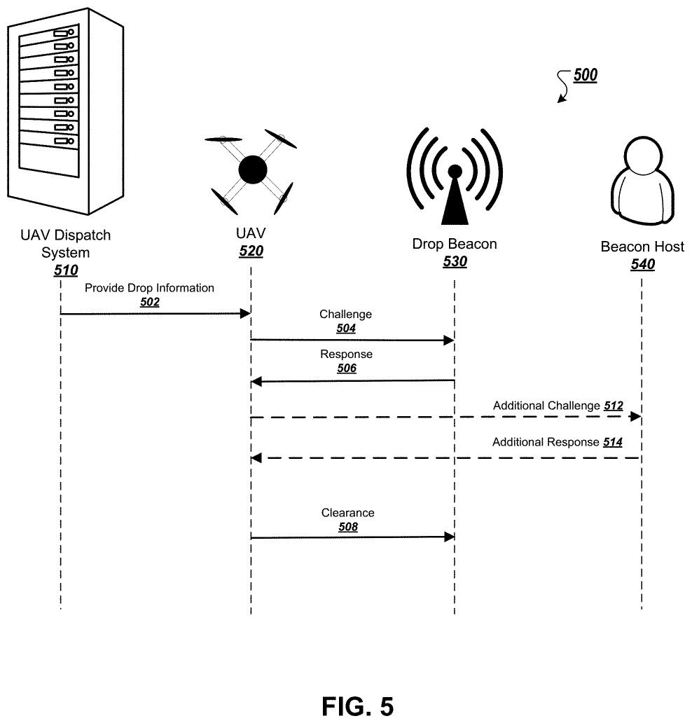

UAV 350 can issue a challenge to, and can receive a response from, drop beacon 340 (steps 316b and 316c). As described in more detail with reference to FIG. 5, UAV 350 and drop beacon 340 can communicate between each other to authenticate drop beacon 340 as the correct drop site initially assigned by UAV dispatch system 330. In some implementations, additional authentication is performed between UAV 350 and customer 310 receiving a delivery or a beacon host receiving a delivery on behalf of customer 310.

For example, the beacon host for beacon 200 can take a picture of the beacon before beginning to host a drop site for UAV dispatch system 330. The picture can be of the beacon and some identifying feature of the drop, e.g., the beacon host's house, or a sign on the property where the drop site is located. Then, UAV 350 can receive the photo as part of the drop information, and upon arriving at beacon 200, visually identify the beacon by comparing with the image provided by the beacon host with a current image taken by UAV 350.

After confirming the identity of beacon 340, UAV 350 visually identifies drop beacon 340 (step 316d). UAV 350 can visually identify beacon 200 by a distinguishing marker on the beacon, such as a fiducial marker. For example, UAV 350 can be configured to process an image of a fiducial marker unique to beacon 200, such as a QR code or other identifier.

UAV 350 performs drop to deliver the package at the drop site corresponding to drop beacon 340 (step 316e). UAV 350 can drop the package at the drop site and the beacon host can retrieve and hand the package off to the customer, after verifying the customer's identification, e.g., as matching information on a customer account on the dispatch application. In some implementations, UAV 350 can drop the package off in a secure location where customer 310 can come retrieve the package at a later time.

Drop beacon 340 confirms drop to UAV dispatch system and UAV 350 (steps 316f and 318). Drop beacon 340 can confirm that the drop was successful immediately after UAV 350 makes the delivery at the drop site, including a time stamp and the verified identity of customer 310 if the customer came directly to pick up the delivery. If a delivery was not successful, drop beacon 340 can send an indication of failure to UAV dispatch system. Delivery can fail for a variety of reasons, e.g., because UAV 350 does not make it to the drop site, because some obstacle at or near the drop site prevented UAV 350 from safely landing, or because drop beacon 340 did not properly authenticate to UAV 350.

Depending on the issue, beacon host can attempt to correct the issue, for example by clearing the obstacle impeding UAV 350. If the beacon host does not correct the issue within a predetermined period of time, then drop beacon 340 can send an indication that the delivery failed to UAV dispatch system 330. In some implementations, drop beacon 340 can be configured to notify UAV dispatch system 330 that the delivery was a failure, if drop beacon 340 does not receive a challenge from UAV 350 within a predetermined period of time after receiving the UDC for the drop request from UAV dispatch system 330.

Drop beacon 340 can be configured to “ration” notifications depending on network congestion. For example, if the drop site for drop beacon 340 is experiencing high traffic volume from multiple UAVs, then drop beacon 340 can be configured to send only drop confirmations to UAV dispatch system 330, and reserve other information in memory to submit in batches. Other information can include statistics tracked by UAV dispatch system 330, e.g., a number of UAVs currently waiting to begin a final descent, an average wait time, and a number of canceled or postponed deliveries due to an obstacle or some obstruction. Batched information can be sent at a later time, such as when drop beacon 340 is not currently active or when traffic volume at the drop site is low.

If a drop was not completed, e.g., for reasons discussed above, UAV dispatch system 330 can notify operator 320. Depending on the issue, operator 320 may have to go to the drop site and collect UAV 350, e.g., because the reason the drop was not completed was because UAV 350 malfunctioned during the delivery. In implementations in which customer 310, operator 320, and UAV dispatch system 330 all communicate through the dispatch application, drop beacon 340 can be configured to automatically send a notification to all parties at or near the same time.

Next, UAV retires the UDC for the delivery and notifies operator 320 of the status of the delivery, e.g., confirmed, canceled, or suspended (step 322). The UDC is retired so that the UDC is not re-assigned for a future drop. UAC dispatch system 330 retires the UDC at least so that the system can accurately track a history of a delivery corresponding to the UDC, and also because the UDC can be used as part of authentication, as described below with reference to FIG. 5.

Operator 320 confirms delivery to customer 310 (step 324). Operator 320 can notify customer 310 of the successful drop regardless of whether or not customer 310 personally was at the drop site to receive the delivery. In some implementations, the dispatch application can provide a notification of a successful delivery to customer 310 automatically after drop beacon 340 confirms the drop was successfully made to UAV dispatch system 330.

As discussed above, if multiple UAVs are making deliveries at the same time, the UAVs can form a priority queue. In response to detecting multiple UAVs near the drop site, drop beacon 340 can be configured to send a respective queue signal to each of the multiple UAVs. Until such time that the drop beacon summons a UAV and rescinds the queue command, the UAV remains in an idle hovering position safely outside the air space of the drop site.

Drop beacon 340 can generate and update queue scores for each UAV in real-time, based on a variety of factors. Initially, drop beacon 340 can assign queue scores as a first-to-arrive, first-to-deliver order for incoming UAVs. Drop beacon 340 can also adjust a UAV's queue score based on technical and delivery characteristics. Drop beacon 340 can compute, or send a request to UAV dispatch 330 to compute, an estimated time each UAV has to wait based on the size of the queue and the queue score of the UAV.

Then, drop beacon 340 can receive an estimated flight time remaining for each UAV, representing how long the UAV can remain in the air because recharging. Based on these two estimations, drop beacon 340 can update queue scores for UAVs that are estimated not to be able to hold a charge long enough to wait in the priority queue.

Alternatively or in addition, drop beacon 340 can factor in characteristics of the respective goods each UAV is delivering. If a UAV is delivering something perishable, e.g., a burrito, then drop beacon 340 can issue a queue score reflecting the perishable nature of the goods, and push the UAV further ahead in the queue over other UAVs delivering non-perishable goods, like socks.

Alternatively or in addition, drop beacon 340 can factor in order parameters specified by the customer who placed the order. For example, customers who specified an ASAP delivery time versus a delivery time scheduled for later can cause drop beacon 340 to issue a higher queue score to a UAV making the corresponding delivery.

Alternatively or in addition, drop beacon 340 can factor in “preferred operators” to adjust corresponding UAVs for the preferred operators in the queue. A preferred operator is an operator that is designated by UAV dispatch system 330 for prioritization for delivery. UAV dispatch system 330 can designate an operator as preferred based on the action of the operator.

For example, if UAVs corresponding to the operator are consistently and promptly making deliveries when scheduled, then UAV dispatch system 330 can designate the operator as preferred, in response. In some implementations, UAV dispatch system 330 can designate an operator as preferred in response to agreements entered by an entity maintaining UAV dispatch system 330 and an operator, e.g., a service-level agreement or a quality-of-service agreement specifying a minimum quality-of-service to be met.

Similarly, UAV dispatch system 330 can remove an operator's “preferred” designation, for example, because the UAVs operated by the operator do not meet a minimum expectation of prompt and correct deliveries.

After an operator has been designated as preferred, UAV dispatch system 330 can be configured to adjust a queue number for a UAV corresponding to a preferred operator so that the UAV is scheduled to deliver ahead of other UAVs. Although UAV dispatch system can designate multiple operators as preferred, the exact amount a queue number is adjusted for a preferred operator's UAV can vary on a case-by-case basis. For example, UAV dispatch system 330 can adjust a queue number by a pre-determined amount corresponding to the operator's preferred status. If multiple UAVs in the queue are operated by preferred operators, then each of the UAVs' position in the queue can be adjusted by a same or unique amount pre-determined for each preferred operator.

In some implementations, the pre-determined amount a UAV's queue number is adjusted by based on a pre-determined formula, which can factor in, for example: a number of UAVs in the queue; an amount of time a UAV is expected to wait in the queue; and a time or date the UAV is making the delivery, e.g., because the operator has preferred status during the holidays or when customer demand for delivery is high.

In some implementations, drop beacon 340 can prompt a customer to “check-in” at the drop site. If the customer does not respond indicating they are currently at the drop site, then drop beacon 340 can update a queue score for the UAV delivering the corresponding order for the customer to be lower in the queue, because the customer is not available to receive the delivery.

In some implementations, drop beacon 340 can update a queue score for a UAV in response to dynamic pricing update sent to a customer by UAV dispatch system 330. If a customer responds to a dynamic pricing update, e.g., by selecting an updated delivery cost in exchange for a faster delivery time, then drop beacon 340 can update a queue score for the corresponding UAV.

FIG. 4 is a screenshot of an example user interface of the dispatch application shown on a customer device for selecting a location to receive goods ordered. The dispatch application can be configured to obtain a current location for customer 310 by any appropriate method, e.g., from a GPS module tracking a current location on a customer device used by customer 310 to make the order, or by customer input. Then, the application can be configured to generate and display a map 410 of the area proximate to the current location of customer 310. The area proximate to the current location can be within a circle of a predetermined radius, for example of a predetermined radius covering an area in which the customer would be likely to arrive at the drop site within the delivery time specified in the order parameters.

The dispatch application can be configured to display map 410 as a selectable element. Customer 310 can select a portion of map 410, e.g., by tapping, long-pressing, or swiping on the display of the customer device if the customer device has a touch-screen, or selecting a portion of map 410 by mouse or keyboard controls. Map 410 can display locations of different drop sites designated by respective beacons in the beacon network maintained by UAV dispatch system 320.

Selecting a portion of map 410 can cause the dispatch application to update the user interface to display a menu 420. Menu 420 can include one or more selectable elements, including a selectable element for confirming a selected location as a drop site in which customer 310 would like to receive the ordered goods. For example, the selectable element for confirming a drop location can be a button.

In some implementations, the user interface is configured such that customer 310 can only select portions of map 410 showing a drop site for a respective beacon. In some implementations, customer 310 can select any portion of map 410, and the user interface is configured to select the drop site on map 410 closest geographically to the selected portion.

After receiving a selection and confirmation from customer 310, the application can be configured to send an order to operator with information that includes the requested location for delivery. Operator 320 can then send a drop request to UAV dispatch system 330.

Customer 310 can receive a prompt including a dynamic pricing update, as described above with reference to FIG. 3, through the user interface of the dispatch application. In response, customer 310 can respond to the prompt through the user interface. After responding to the request for value-added service, the process to make the delivery by the UAV continues as described in FIG. 3. Later, customer 310 can receive, through the user interface of the application, a confirmation that the delivery has been successfully made. Alternatively, customer 310 can receive an indication that the delivery was not made, or other information related to the delivery, e.g., delay or change in approximate delivery time.

In some implementations, the dispatch application is configured to display a corresponding screen of a user interface corresponding to input or output between customers, operators, beacon hosts, and the UAV dispatch system, including the drop beacons. For example, when a beacon host accesses the dispatch application through a beacon host account, the beacon host can review all drop beacons corresponding to the beacon host, and change a status of each beacon. In addition, the user interface can also display a queue of all UAVs waiting to make a delivery at the drop site.

As another example, if an operator accesses the dispatch application through an operator account, the operator can see a status of each pending order the operator is making a delivery through one or more UAVs, which can also be listed. Information about each UAV can be displayed, such as an operating status and a current task the UAV is assigned to perform.

As another example, if a customer accesses the dispatch application through a customer account, the customer can see a status of pending orders they have made for delivery. Each order can include order information provided by the customer, as well as any dynamic pricing updates that the customer has selected or has been prompted to select. The customer can also see a history of deliveries for previous orders. At the user interface, the customer can also receive notifications of the status of a delivery, generated from information tracked by the UAV dispatch system.

In some implementations, the UAV dispatch system can track and send to a dispatch application delivery updates in real-time, e.g., when a drop request has been made, when a drop beacon has been matched, and when a UAV is in range of the drop beacon. If a UAV is in a queue waiting to make the final descent, then the UAV dispatch system can additionally notify the customer through the dispatch application, and can include an estimated waiting time. At this time, the UAV dispatch system can also send the customer a dynamic pricing update, if appropriate, prompting the user to incur a greater delivery cost in exchange for a faster delivery.

As described above, a UAV dispatch system can be configured not to send dynamic pricing updates if other UAVs ahead in the queue have technical or delivery constraints that would compromise a delivery, e.g., because the UAV is low on power, or because the goods in the delivery are perishable.

FIG. 5 is a flowchart 500 of example interactions between parties for performing an authentication protocol during delivery to a drop site. FIG. 5 describes in more detail an example implementation for authenticating a drop beacon by a UAV before beginning a final descent to a drop site corresponding to the drop beacon. Specifically, FIG. 5 shows an example implementation of performing steps 316b and 316c of FIG. 3, described above.

UAV dispatch system 510 provides drop information to UAV 520 (Step 502). As described above with reference to FIG. 3, UAV dispatch system 510 can provide drop information including coordinates for a drop beacon 530 assigned to UAV 520 for delivery. In addition, the drop information can include a beacon ID uniquely identifying drop beacon 530 from other beacons in beacon network, which can also function as a cryptographic public key for drop beacon 530. The drop information can also include a UDC assigned in response to a drop request for the delivery.

After arriving within an approximate area encircling the drop site of drop beacon 530 to begin a final descent, UAV 520 can issue a challenge to drop beacon 530 (step 504). The challenge can follow any appropriate digital signature verification protocol, including digital signature algorithm (DSA) and any appropriate variant relying on public key cryptography. The challenge can be for drop beacon 520 to verify its identity by digitally signing some verifiable information, such as the UDC for the drop. Because UDCs are retired after use, a UDC can be used for authenticating drop beacon 520, so long as UAV dispatch system 510 generates unique UDCs in a manner in which the chance of repeating a UDC is very low, i.e., negligible as a cryptographic guarantee.

Drop beacon 530 responds to the challenge (step 506). Drop beacon 530 can reply in any appropriate manner, depending on the challenge issued by UAV 520. In some implementations in which UAV 520 challenges drop beacon 530 to sign the UDC, drop beacon 530 can respond by signing the UDC with its cryptographic private key.

UAV 520 can verify the response received from drop beacon 530, and if the response successfully meets the challenge, clears drop beacon 530 and proceeds with delivery, e.g., as described above with reference to FIG. 3 (step 508). For example, UAV 520 can verify the received signature from drop beacon 530 using the public key for the drop beacon as previously received from UAV dispatch system 510. If drop beacon 530 is authentic, then verifying the received signature using the public should reveal the UDC for the delivery.

Upon clearance, custody of the delivery passes from UAV 520 to beacon host 540. Beacon host 540, as part of their responsibilities as a host, takes responsibility to ensure that the delivery is received by the customer. Beacon host 540 can implement additional security features or authentication protocols of their own to verify a customer's identity before making a final hand-off. In some implementations, UAV dispatch system 510 can provide customer-provided information about the customer receiving the package to beacon host 540 through the dispatch application. Before handing off the delivery to the customer, beacon host 540 can verify the identity of the customer using the information provided through the dispatch application.

If UAV 520 checks the received signature and does not verify the signature, e.g., because applying the public key to the signature did not result in the UDC for the delivery, then in some implementations UAV 520 is configured to return to its respective operator. UAV 520 can then notify UAV dispatch system 510 that it was unable to properly authenticate drop beacon 530. Then, the location where UAV 520 traveled and drop beacon 530 can be further investigated, with the location temporarily blacklisted by UAV dispatch system 510 until investigation into the failure is complete.

To be blacklisted means that UAV dispatch system 510 treats drop beacons in the zone as inactive regardless of their actual status. A location or general area can be blacklisted for different reasons, besides a potential security risk as described here. For example, a location can be blacklisted by UAV dispatch system 510 in response to reports of UAVs damaged or stolen while making deliveries in that area. Short of blacklisting, negative reports about an area around a drop beacon or poor ratings of a beacon host managing the drop beacon can cause UAV dispatch system 510 to assign drop requests to the drop beacon less frequently.

Optionally, UAV 520 can issue an additional challenge to beacon host 540 hosting drop beacon 530 (step 512). UAV 520 can issue an additional challenge as a requirement specified in order parameters from a customer for the order, for example because the customer has requested that the service host receive and store the delivery. In some implementations, if UAV 520 was not able to clear drop beacon 530 at step 508, UAV 520 can be configured to send an additional challenge to beacon host 540.

In some implementations, UAV 520 is configured to receive an additional challenge from beacon host 540 through the dispatch application, or drop beacon 530 directly. UAV 520 can be challenged in response to UAV 520 making a delivery to drop beacon 530 that has been designated as a “low-trust” drop beacon. As described above, a drop beacon can be designated as “low-trust” and “high-trust,” or by some equivalent labelling to designate whether deliveries to a drop beacon require additional challenges for authentication or not.

For example, if drop beacon 530 is designated as low-trust, then, as part of authentication, an additional challenge (step 512) and an additional response (step 514) can be performed by UAV 520 and beacon host 540 respectively. Alternatively or in addition, additional challenges can be issued by beacon host 540 for response by UAV 520. Beacon host 540 can issue an additional challenge for additional proof that UAV 520 is the same UAV that received the drop information from UAV dispatch system 520.

UAV 520 can issue the additional challenge through a dispatch application accessed by beacon host 540 through a computing device (step 512). For example, beacon host 540 can receive a notification from UAV 520 indicating that UAV 520 has issued an additional challenge. In general, a challenge for beacon host 540 can be to take a picture of a fiducial marker on UAV 510. The fiducial marker can large enough for a conventional smartphone camera to take a picture in clear enough detail, even while UAV 510 is hovering above the drop site.

Another example of a challenge is for beacon host 540 to verify through the dispatch application that they are available and ready to receive the package. In this example, beacon host 540 is affirming that custody has passed from UAV 520 to them. If at a later point, a customer comes to receive their package, custody and responsibility for the delivery is assumed to lie with beacon host 540.

Beacon host 540 provides a response to the additional challenge (step 514). As described with reference to step 512, the nature of the response depends on the challenge. For example, if the challenge was to take a picture of a fiducial marker on UAV 520, then the response can be sending the photo to UAV dispatch system 510 through the dispatch application. UAV dispatch system 510 can verify the fiducial marker against information about UAV 510, and in response communicate with drop beacon 530 to send a signal confirming that beacon host 540 has correctly responded to the additional challenge.

Similarly, if the challenge by UAV 520 is to verify that beacon host 540 is available to receive the delivery through the dispatch application, then upon confirmation from beacon host 540, UAV dispatch system 510 can cause drop beacon 530 to send a signal confirming that beacon host 540 has correctly responded to the additional challenge.

Beacon host 540 can issue additional challenges to UAV 520 in ways similar to as described above. For example, beacon host 540 can request that UAV 520 take a picture of the drop site for drop beacon 530. UAV 520 can then take and send the picture to beacon host 540 through the dispatch application. Beacon host 540 can compare the received picture and compare it to the drop site as it currently appears at the time UAV 520 is scheduled to make a delivery. Based on the comparison, beacon host 540 can then authenticate UAV 520 through the dispatch application, and UAV 520 can proceed to make a delivery as described above.

In some implementations, instead of beacon host 540 making a comparison between a picture and the drop site, UAV dispatch system 510 can be configured to automatically compare the picture taken by UAV 520 in response to the challenge, with a stored reference picture. UAV dispatch system 510 can be provided a reference picture by beacon host 540, for example when beacon host 540 sets drop beacon 530 to active. Alternatively, UAV dispatch system 510 can take a picture of the drop site through drop beacon 530, e.g., by using a camera installed on drop beacon 530.

However UAV dispatch system 510 obtains the reference picture, UAV dispatch system 510 can then compare the reference picture to the picture taken by UAV 520 in response to the challenge by beacon host 540. To do so, UAV dispatch system 510 can apply any conventional technique for image comparison known in the art, e.g., by matching features between the pictures, or by taking and comparing histograms between the pictures. If UAV dispatch system 510 determines that the pictures match within an acceptable threshold, then UAV dispatch system 510 can indicate to beacon host 540 that UAV 520 is authentic, or otherwise automatically approve UAV 520 for landing at the drop site without input from beacon host 540.

As described above, drop sites can be designated as “low-trust” or “high-trust” drop beacons, and description turns now to the latter. A “high-trust” drop beacon is a drop beacon in which authentication requirements between a delivering UAV and a drop beacon are reduced or removed altogether. For example, the UAV dispatch system can designate a drop beacon as high-trust because of the geographic location where the drop beacon is located. For example, a drop beacon deployed at a college or work campus can be designated high-trust by the UAV dispatch system, for example because a campus usually have higher levels of security over other locations where a drop beacon can be deployed, e.g., a residential neighborhood.

Another example is that the beacon host for the drop beacon is the same entity that maintains the campus, and has requested “high-trust” status for its deployed drop beacons in the campus. In this example, an additional requirement can be imposed by the UAV dispatch system that only UAVs operated by the beacon host are scheduled for delivery at corresponding drop sites. The need to authenticate UAVs are drop sites for high-trust drop beacons is obviated because the UAVs are operated by the same entity maintaining the drop beacons.

In general, the drop beacon network maintained by the UAV dispatch system can include both high-trust and low-trust drop beacons, as well as drop beacons that shift status over time, e.g., from low-trust to high-trust or vice versa. The UAV dispatch system can maintain authentication requirements for each drop beacon, requiring additional challenges for low-trust drop beacons, as necessary. Because the status of one drop beacon does not necessarily affect the status of another drop beacon, the UAV dispatch system can flexibly maintain authentication requirements based on beacon status to enhance convenience for beacon hosts, operators, and customers, without irresponsibly sacrificing its role as a secure third-party facilitator as each type of entity engage in transactions with no expectation of trust.

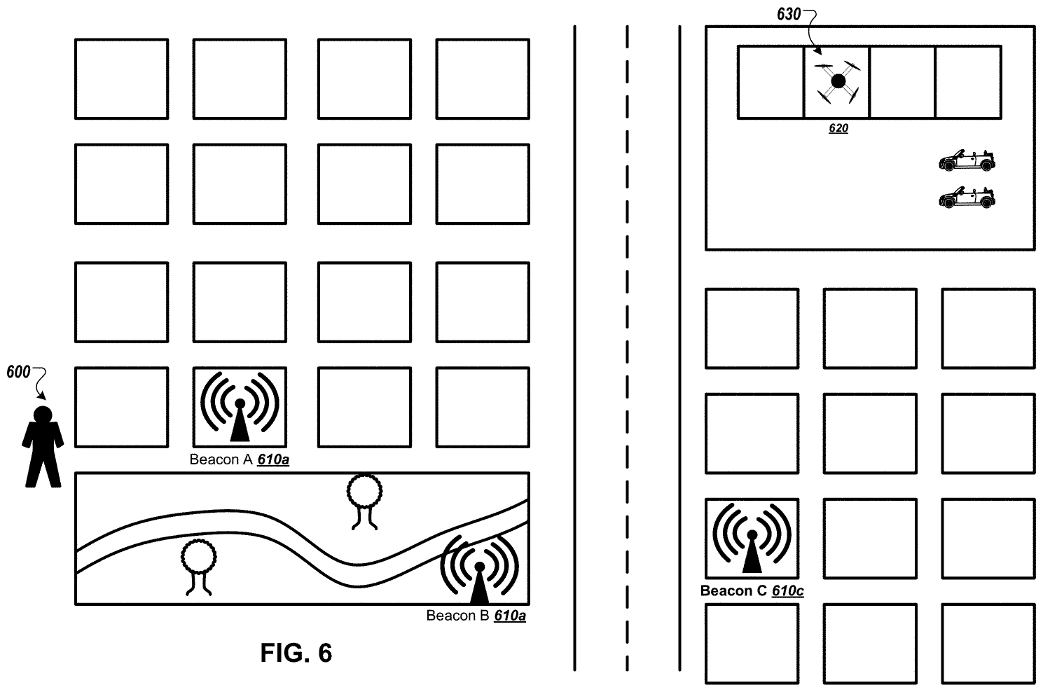

FIGS. 6-8 illustrate an example delivery by a UAV according to one implementation.

Referring to FIG. 6, customer 600 places an order through a dispatch application of a UAV dispatch system having a beacon network of three beacons: beacon A 610a, beacon B 610b, and beacon C 610c (for brevity, beacon A, B, and C). In this example, customer 600 selects a location near beacon B, for example because customer 600 wants to take a walk through the park and treat themselves with a burrito. Operator 620 receives the burrito order and sends a drop request to the UAV dispatch system.

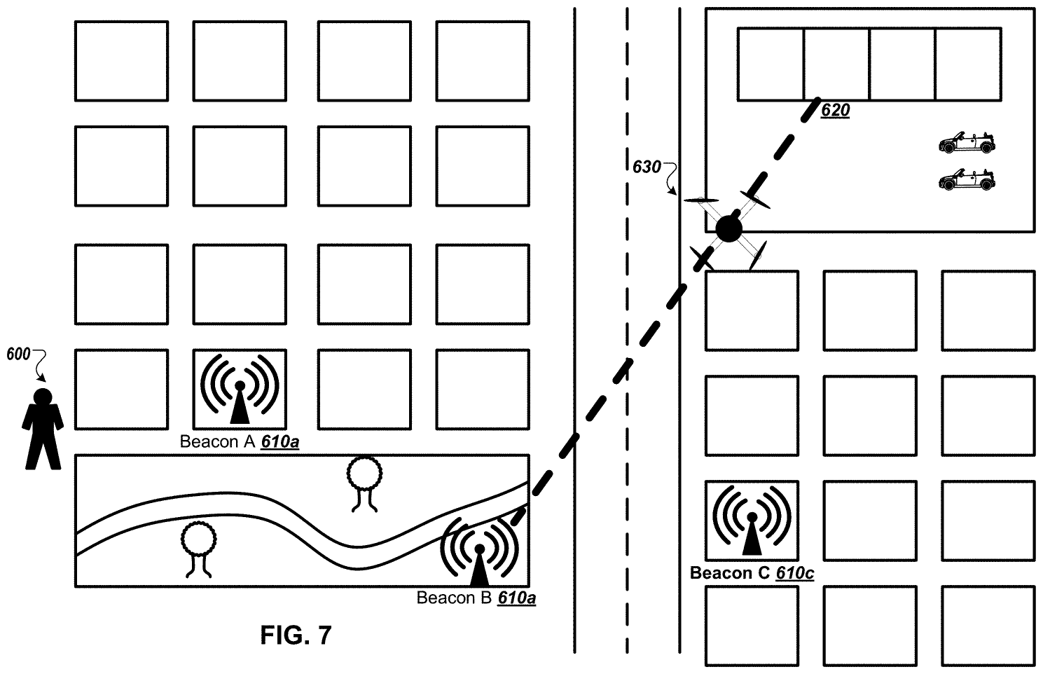

Referring to FIG. 7, in response to the drop request, operator 620 receives drop information for beacon B as a match, reflecting customer 600's requested location in the park. In general, a delivery cost to customer 600 is less for requested locations that are further away from the customer's current position. In other situations, however, closer drop sites may incur a cheaper delivery cost to customer 600 over farther drop sites. For example, there could be a festival in the park where beacon B is located, which can cause the delivery cost to increase because of increased demand for deliveries in that area. FIG. 7 also shows UAV 630 beginning to travel to beacon B.

During transit to beacon B, UAV 630 can be instructed to cancel or change a drop site for a delivery. In some implementations, the UAV dispatch system is configured to instruct the UAV to cancel or change a drop site for a delivery automatically. Operator 620 can cancel a delivery for a variety of reasons, stemming from decisions by operator 620, the UAV dispatch system, and/or customer 600.

For example, customer 600 can cancel a delivery mid-transit because they do not wish to have the good delivered anymore. In some implementations, the UAV dispatch system can charge a cancellation fee to customer 600, to reimburse operator 620 for the effort in preparing and beginning to deliver the good. The exact amount the UAV dispatch system can charge as a cancellation fee can vary, for example based on late after the initial request customer 600 canceled the order, or how far the UAV had traveled prior to the customer canceling the order.

As another example of when an order can be canceled, operator 620 can cancel an order based on circumstances affecting UAV 630 or the operator's ability to satisfy the order. For example, if operator 620 is unable to make the delivery within a pre-determined time estimated by the UAV dispatch system, then customer 600 can receive a prompt through the dispatch application notifying them of this delay, with an option to cancel the order. Additionally, if UAV 630 becomes unable to make the delivery, e.g., because of hardware or software malfunction, then operator 620 can cancel the delivery. Alternatively, the UAV dispatch system can be configured to cancel the delivery automatically.

As another example, the UAV dispatch system can be configured to cancel the delivery of UAV 630 to beacon B because of un-resolvable obstructions en route to beacon B. In addition, if beacon B has resolvable obstructions that are not addressed by the UAV dispatch system and/or the beacon host for beacon B within a pre-determined period of time, then in response the UAV dispatch system can cancel the delivery.

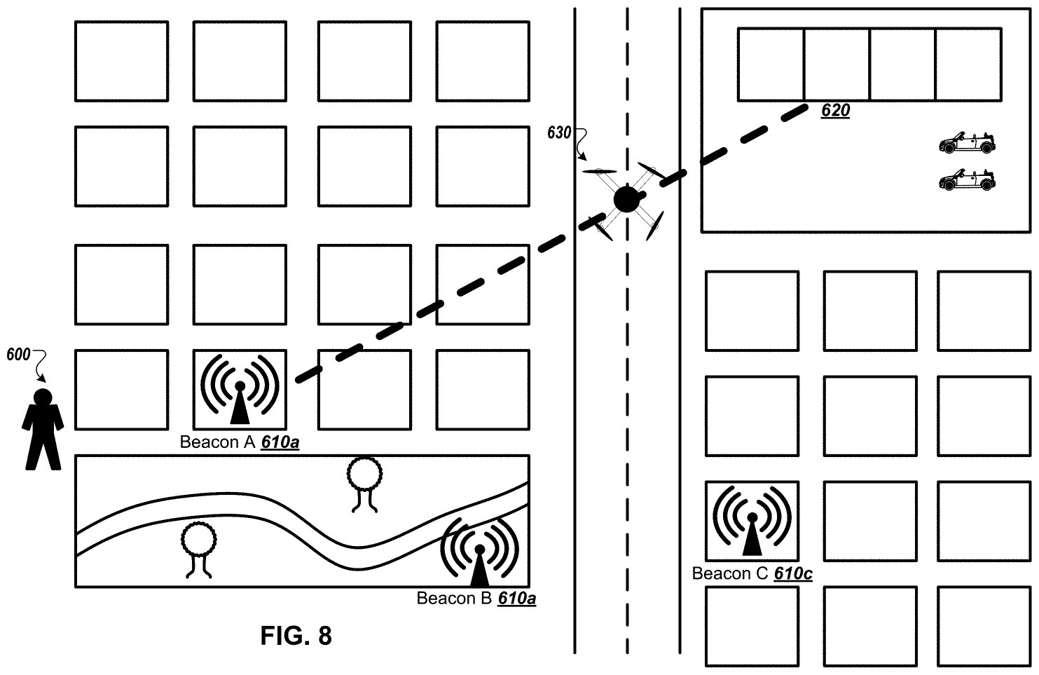

Referring to FIG. 8, customer 600 decides to change the drop site for their delivery instead of canceling the delivery. The dispatch application can be configured to keep track of a general position of UAV 630, and maintain in real-time an option for customer 600 to update a drop site. The dispatch application can also be configured to retrieve a dynamic pricing update for changes to the delivery, such as a change in drop site. Customer 600 can receive a prompt to update the drop site to beacon A.

Customer 600 may wish to change the drop site for any reason. For example, customer 600 may decide it is too hot outside to go to the park, but still wishes to have the burrito for lunch. Customer 600 can update the drop site for their delivery and potentially pay an additional delivery fee based on the dynamic pricing update.

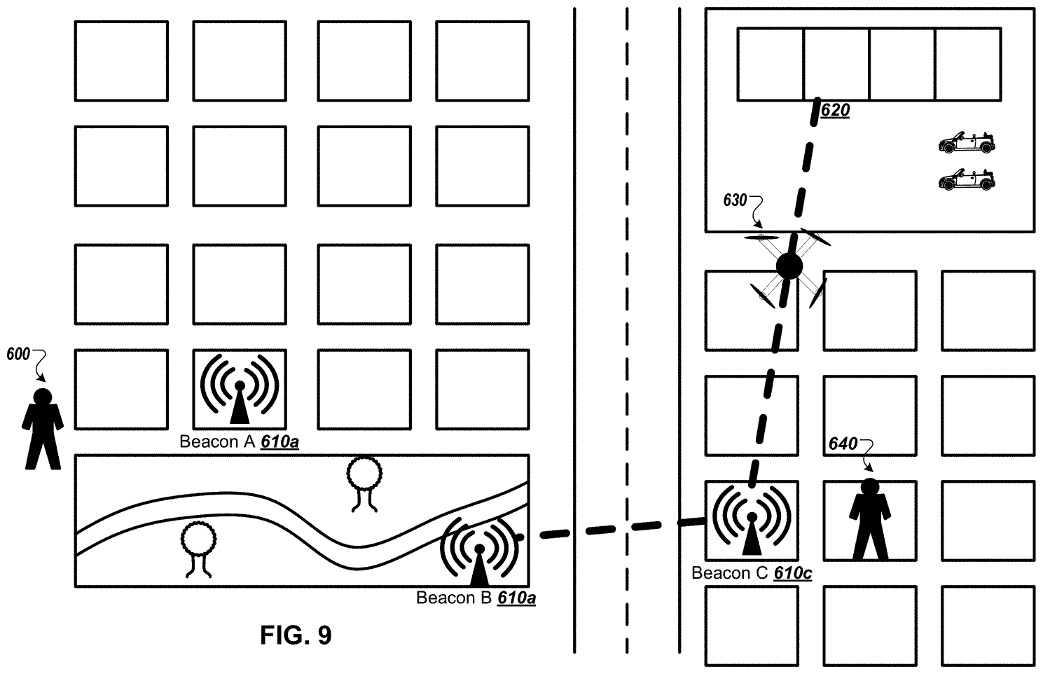

FIG. 9 illustrates an example delivery by a UAV according to another implementation. As described above, with reference to FIG. 6, customer 600 orders a burrito, operator 620 sends a drop request to the UAV dispatch system, and receives a match and drop information for beacon B. As operator 620 is preparing the burrito for customer 600, operator 620 receives another order for a burrito for customer 640, who selected a location near beacon C for delivery. After sending another drop request to the UAV dispatch system, operator 620 receives a match for beacon C to deliver customer 640's burrito.

In this example, operator 620 has a single UAV 630. In this example, UAV 630 can make a delivery to beacon C for customer 640 before making a delivery to beacon B for customer 600. For example, UAV 630 can be scheduled by the UAV dispatch system in response customer 640 responding to a prompt for a dynamic pricing update.

Alternatively, the UAV dispatch system could send a dynamic pricing update to customer 600 instead of customer 640. If customer 600 responds to the dynamic pricing update, then before UAV 630 can be schedule to make a delivery at beacon B for customer 600 before beacon C for customer 640.

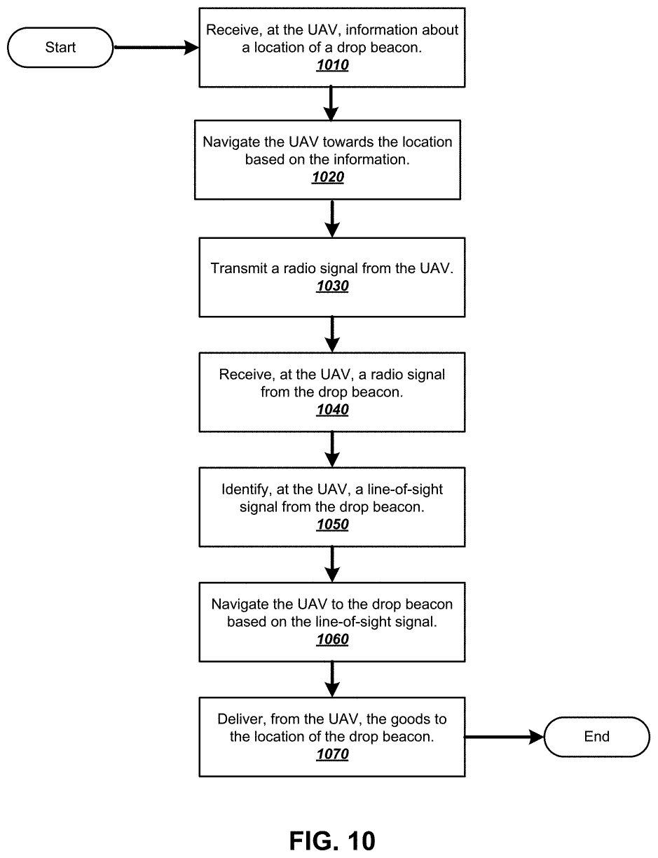

FIG. 10 is a flowchart of an example process 1000 for a UAV to locate and arrive at a drop site indicated by a drop beacon in a cone representing an approximate location. For convenience, the process 1000 will be described as being performed by a system of one or more computers, located in one or more locations, and programmed appropriately in accordance with this specification. For example, a UAV and a drop beacon, e.g., the UAV 102 shown in FIG. 1, appropriately programmed, can perform the process 1000.

The UAV receives information about a location of a drop beacon (step 1010). As described above with reference to FIG. 3, the UAV dispatch system can send drop information to the operator, and the operator in turn can provide drop information to the UAV.

The UAV navigates towards the location based on the information (step 1020). As described above with reference to FIG. 3, the UAV can fly towards the drop site designated by a drop beacon described in the drop information received by the UAV. The UAV can fly manually or automatically, and can use any conventional technique for navigating an airspace, until reaching an approximate location of the drop beacon.

The UAV transmits a radio signal (step 1030). The UAV can transmit a radio signal to receive a response from the drop beacon. As described above with reference to FIG. 3 and FIG. 6, the UAV can issue a number of challenges to the drop beacon to verify that the drop beacon is the same drop beacon described in the drop information received from the UAV dispatch system.

The UAV receives a radio signal from the drop beacon (step 1040). As described above with reference to FIG. 3 and FIG. 6, the drop beacon can respond to challenges from the UAV to verify the identity of the drop beacon.

The UAV identifies a line-of-sight signal from the drop beacon (step 1050). As described above with reference to FIG. 4, the UAV can establish a line-of-sight signal with the drop beacon to guide the UAV to the drop site.

The UAV navigates to the drop beacon based on the line-of-sight signal (step 1060). As described above with reference to FIG. 4, the UAV can continue to fly towards the drop beacon using the established line-of-sight signal as a guide.

The UAV delivers the goods to the location of the drop beacon (step 1070). As described above with reference to FIG. 3, the UAV can deliver the goods at the drop site designated by the drop beacon.

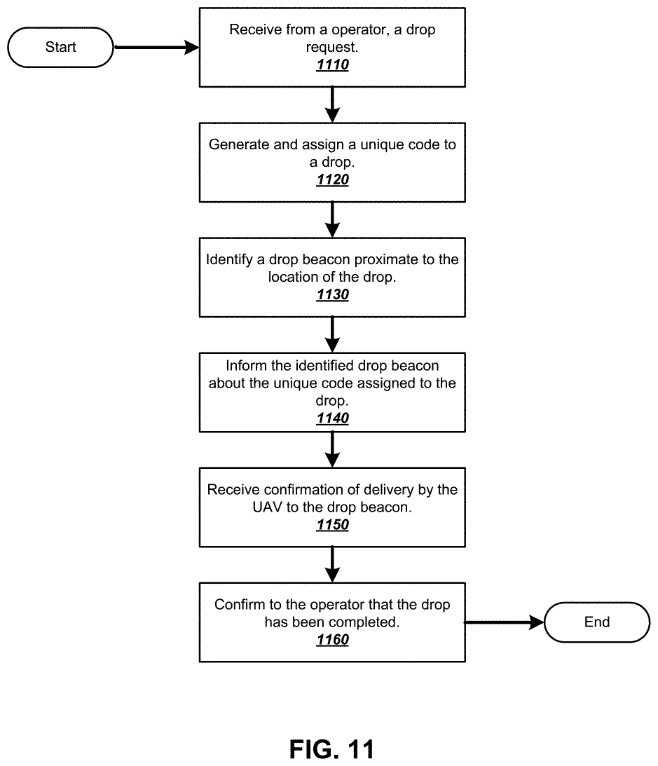

FIG. 11 is a flowchart of an example process 1100 for matching a drop request to an available drop beacon, and confirming delivery by a UAV at the drop beacon location. For convenience, the process 1100 will be described as being performed by a system of one or more computers, located in one or more locations, and programmed appropriately in accordance with this specification. For example, a UAV dispatch system, e.g., the UAV dispatch system 100 of FIG. 1, appropriately programmed, can perform the process 1100.

The UAV dispatch system receives a drop request from an operator (step 1110). As described above with reference to FIG. 3, the operator can send a drop request in response to receiving an order from a customer for a good or goods.

The UAV dispatch system generates and assigns a unique code to a drop (step 1120). As described above with reference to FIG. 3, the UAV dispatch system can generate a universal drop code uniquely identifying the requested drop.

The UAV dispatch system identifies a drop beacon proximate to a location of the drop (step 1130). As described above with reference to FIG. 3 and FIGS. 6-9, the UAV dispatch system can identify a drop beacon proximate to a location of a customer or a location indicated by the customer for a UAV to make a delivery. The UAV dispatch system includes one or more drop beacons designating respective drop sites where the UAV can make a delivery. The selected drop beacon can depend on the nature of the goods, a customer-designated window of delivery, and a customer-assigned priority level.

The UAV dispatch system informs the identified drop beacon about the unique code assigned to the drop (step 1140). As discussed above with reference to FIG. 3, the UAV dispatch system can send the UDC for the drop to the drop beacon of the drop site designated for delivery.

The UAV dispatch system receives confirmation of delivery by the UAV to the drop beacon (step 1150). As described above with reference to FIG. 3, after the UAV makes the delivery, the drop beacon can confirm that the delivery was successful and send a confirmation to the UAV. In some implementations, the drop beacon does not confirm a delivery until a drop beacon manager for the drop beacon manually confirms the delivery was made successfully. In some implementations, the drop beacon does not confirm deliver until the customer acknowledges the delivery was made, e.g., by indicating the delivery was made on an application used to make an initial order that caused the operator to make a drop request to the UAV dispatch system.

The UAV dispatch system confirms to the operator that the drop has been completed (step 1110). As discussed above with reference to FIG. 3, after confirming to the operator that the drop has been completed, the UAV dispatch system can retire the UDC assigned to the drop, to prevent the UDC from being reused for a future drop.

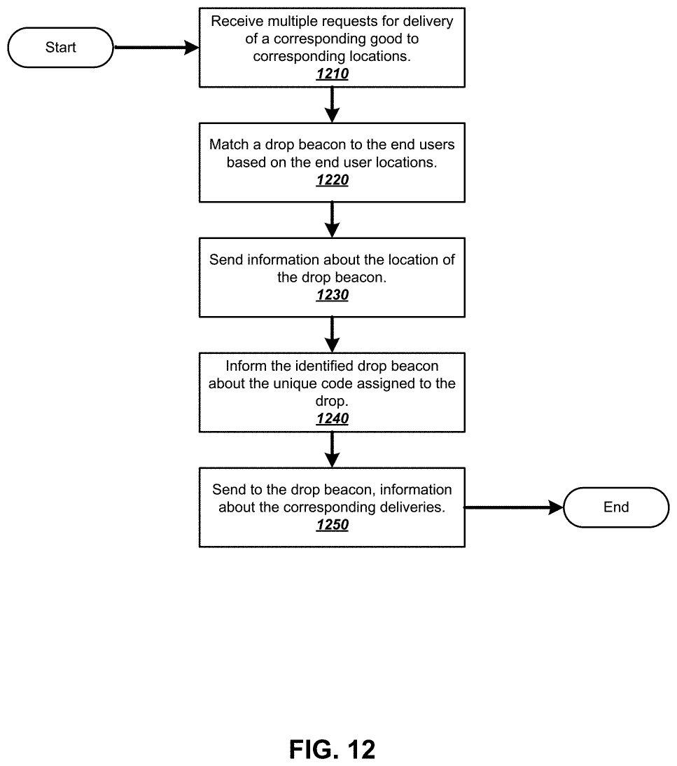

FIG. 12 is a flowchart of an example process 1200 for managing airspace at a drop site designated by a drop beacon. For convenience, the process 1200 will be described as being performed by a system of one or more computers, located in one or more locations, and programmed appropriately in accordance with this specification. For example, a UAV dispatch system, e.g., the UAV dispatch system 100 of FIG. 1, appropriately programmed, can perform the process 1200.

The UAV dispatch system receives multiple requests for delivery of a corresponding good to corresponding customer locations (step 1210). As described above with reference to FIG. 3, the UAV dispatch system can manage multiple drop requests from multiple operators, and manage prioritization and deconfliction according to one or more factors.

The UAV dispatch system matches a drop beacon to the customers based on the customer locations (step 1220). As described above with reference to FIG. 3, the selected drop beacon can depend on the nature of the goods, a customer-designated window of delivery, a customer-assigned priority level, or in response to a dynamic pricing update sent to the customer from the UAV dispatch system.

The UAV dispatch system sends information about the location of the drop beacon (step 1230). As described above with reference to FIG. 3, once the UAV has the location of the drop beacon, the UAV can begin flying to the drop beacon, until arriving within an approximate area of the drop site.

The UAV dispatch system informs the identified drop beacon the information about the corresponding good drops (step 1240). As described above with reference to FIG. 3 and FIG. 5, the information can include a queue score, or generally priority information for the drop beacon to prioritize delivery of the goods to the drop beacon assigned by the UAV dispatch system when the operator made a drop request.

The UAV dispatch system sends information about the corresponding drops to the drop beacon (step 1250). As described above with reference to FIG. 3, if multiple UAVs arrive at the drop beacon at the same time, then the drop beacon an issue a queuing signal to each UAV and call UAVs to perform a final descent to the drop site in order of queue score. The drop beacon can then summon UAVs in order to take delivery, specified by the priority queue and based on the priority information.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being or may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. An automated process for delivering goods to a location using an unmanned aerial vehicle (UAV), the process comprising:
receiving, at the UAV, information about a location of a drop beacon comprising GPS coordinates of a location of a drop beacon;
navigating the UAV towards the location based on the information using GPS coordinates of the drop beacon;
when reaching a proximity of the drop beacon, transmitting a first radio signal from the UAV with information relatable by the drop beacon;
receiving, at the UAV, a second radio signal from the drop beacon;
identifying, at the UAV, a line-of-sight signal from the drop beacon;
navigating the UAV to the drop beacon based on the line-of-sight signal; and
delivering, from the UAV, the goods to the location of the drop beacon.

2. The process of claim 1, wherein the first radio signal comprises a challenge to authenticate the drop beacon, and wherein the second radio signal comprises a response to the challenge, and the process further comprising:
determining, at the UAV, that the drop beacon correctly responded to the challenge; and
in response to determining, at the UAV, that the drop beacon did not correctly respond to the challenge, navigating the UAV away from the drop beacon.

3. The process of claim 1, wherein the drop beacon is maintained by a beacon host, and wherein the process further comprises:
transmitting a challenge to a computing device accessible to the beacon host and configured to receive a challenge from the UAV;
receiving a response to the challenge from the computing device;
determining that the computing device correctly responded to the challenge; and
in response to determining, at the UAV, that the drop beacon did not correctly respond to the challenge, navigating the UAV away from the drop beacon.

4. The process of claim 1, wherein the drop information comprises a unique drop code associated with a delivery of the goods by the UAV to the location of the drop beacon.

5. The process of claim 1, wherein reaching the proximity of the drop beacon comprises navigating the UAV towards the location until detecting that an accuracy of the navigating has fallen below a predetermined threshold.

6. The process of claim 1, wherein the process further comprises:
receiving, at the UAV, a confirmation that the goods were delivered to the location of the drop beacon.

7. The process of claim 1, wherein the drop beacon is one of a plurality of drop beacons each maintained by a respective beacon host.

8. The process of claim 1, wherein identifying, at the UAV, the line-of-sight signal from the drop beacon comprises:
identifying, on the drop beacon, a fiducial marker unique to the drop beacon, using a camera on the UAV; and
maintaining visual contact with the fiducial marker.

9. The process of claim 1, further comprising generating a queue score for the UAV, comprising:
obtaining, at a data processing system, characteristics of the UAV and respective goods for the UAV; and
generating the queue score for the UAV based on the obtained characteristics.

10. The process of claim 9, wherein the characteristics comprise technical characteristics of the UAV, including a current power level for the UAV.

11. The process of claim 9, wherein the characteristics comprise goods characteristics of corresponding goods to be delivered by the UAV, including whether or not the corresponding goods are perishable.

12. The process of claim 9, further comprising:
updating the queue score for the UAV and a queue score of two or more UAVs before the UAV is summoned by the drop beacon.

13. The process of claim 1, wherein the priority information comprises a respective queue score for each UAV of the two or more UAVs, each queue score for a respective UAV indicating a position to take a delivery from the respective UAV out of the two or more UAVs.

14. A system comprising one or more computers and one or more storage devices on which are stored instructions that are operable, when executed by the one or more computers, to cause the one or more computers to perform operations for delivering goods to a location using an unmanned aerial vehicle (UAV), the operations comprising the process of any one of claim 1.

15. One or more computer-readable storage media encoded with instructions that, when executed by one or more computers, cause the one or more computers to perform operations for delivering goods to a location using an unmanned aerial vehicle (UAV), the operations comprising the process of claim 1.

16. An automated process for facilitating delivery of goods to a location using an unmanned aerial vehicle (UAV), the process comprising:
receiving, at a data processing system, a drop request comprising information about a location for delivery of the goods;
generating and assigning, by the data processing system, a unique code to a drop corresponding to delivery of the goods;
identifying, by the data processing system, a drop beacon proximate to the location of the drop based on the information about the location of the drop;
informing the identified drop beacon, from the data processing system, about the unique code assigned to the drop;
receiving, at the data processing system from the drop beacon, confirmation of delivery of the goods to the drop beacon by the UAV; and
confirming, by the data processing system, that the drop has been completed.

17. The process of claim 16, further comprising in response to determining that the response does not correctly answer the challenge, flying away from the drop beacon.

18. The process of claim 16, wherein the drop beacon is managed by a beacon host.

19. The process of claim 16, wherein sending the challenge comprises:
sending an additional challenge to the beacon host; and
receiving a response to the additional challenge from the beacon host.

20. A system comprising one or more computers and one or more storage devices on which are stored instructions that are operable, when executed by the one or more computers, to cause the one or more computers to perform operations comprising the process of claim 16.
